(19) United States
(12) Patent Application Publication
(10) Pub. No.: US 2016/0278877 A1
(43) Pub. Date: Sep. 29, 2016

(54) Temperature-controlled fluid delivery system

(71) Applicant: Alvin M. Pepito, La Habra, CA (US)

(72) Inventor: Alvin M. Pepito, La Habra, CA (US)

(21) Appl. No.: 14/668,950

(22) Filed: Mar. 25, 2015

(51) Int. Cl. A61C 1/00; A61C 17/02

(52) U.S. Cl. CPC A61C 1/0069; A61C 1/0084; A61C 17/0202

(57) ABSTRACT

An apparatus that delivers a temperature-controlled fluid to a dental handset includes a tube assembly including an outer tube and a first inner tube. The first inner tube includes a first input end configured to removably attach to a first source port of a system delivering a first fluid and a first output end configured to removably attach to a first input port in the dental handset. The tube assembly also includes a heating element making good thermal contact with the first inner tube, and a first temperature sensor. The heating element and the first temperature sensor are configured to be operably connected to a temperature control unit such that the temperature control unit controls the heating element in response to a signal received from the temperature sensor.

### BACKGROUND

The delivery of streams of water and/or air into patients' mouths, sometimes carried out in support of another more complicated dental procedure, is an established part of current dental practice. When, as is typical, the temperature of the fluid being delivered is significantly below normal human body temperature, the patient experiences discomfort. In some cases, the discomfort may reach the level of pain, seriously impacting the patient's ability to tolerate whatever dental procedure is being performed.

Two main categories of systems have been developed that aim to deliver fluids to the mouth at temperatures closer to body temperature, but neither has met with widespread acceptance. In one category of fluid delivery systems, the approach has been to incorporate a heating element and associated controls into the hand-held unit—the “handset”—from which the fluid streams are directed into the mouth of the patient. The modified handset receives the fluids through a simple tubing assembly connected at the far end to a dental cart. Air and water ports at the cart connect in turn to convenient fluid sources, which normally supply those fluids at relatively cool or uncontrolled ambient temperatures. In the second category of fluid delivery systems, temperature control is carried out within dedicated fluid reservoirs, or in a preliminary manual-heating step before those reservoirs are filled. The reservoirs may be within or attached to a dental cart or tray, the temperature adjusted fluids then being fed through a tubing assembly from the cart or tray to reach a standard, unmodified handset.

One major disadvantage of the former category of systems is susceptibility to bacterial growth within the handset, as it is difficult to sterilize a handset that includes the electronics required to provide the controlled heating. A second disadvantage is simply the cost of replacing existing handsets with these heater-augmented versions. A third problem is the difficulty of transferring sufficient heat to the moving fluid within the limited volume of the handset without overheating the other parts of the unit, wasting energy and potentially making the handset uncomfortable or even unsafe to hold.

The main disadvantages of the latter reservoir-based category of systems are the increased space taken up by the reservoirs, and overheating and energy efficiency issues, because of the thermal losses suffered during the relatively long fluid passage from the reservoirs through the tubing and the handset to the mouth. Cases that depend on the water to be delivered being heated on a patient-by-patient basis, prior to filling a reservoir, clearly have an additional “time and trouble” disadvantage.

It is therefore desirable to provide an apparatus that can efficiently transfer heat to water and air and efficiently maintain each fluid at the desired temperature until it is as close as possible to reaching the patient. It would be particularly beneficial if this apparatus were compatible with the use of an unmodified dental handset, allowing standard sterilization procedures to be carried out as necessary. Ideally, the apparatus would also interface simply and smoothly with standard dental cart fixtures, incurring minimal additional cost.

### SUMMARY

The present invention includes an apparatus that delivers a temperature-controlled fluid to a dental handset. The apparatus comprises a tube assembly comprising an outer tube and a first inner tube. The first inner tube comprises a first input end configured to removably attach to a first source port of a system delivering a first fluid; a first output end configured to removably attach to a first input port in the dental handset; a heating element making good thermal contact with the first inner tube; and a first temperature sensor. The heating element and the first temperature sensor are configured to be operably connected to a temperature control unit such that the temperature control unit controls the heating element in response to a signal received from the temperature sensor.

In one aspect the tube assembly additionally comprises a second inner tube comprising a second input end configured to removably attach to a second source port of a system delivering a second fluid; and a second output end configured to removably attach to a second input port in the dental handset; wherein the heating element further makes good thermal contact with the second inner tube. In another aspect, the first fluid is water and the second fluid is air.

### BRIEF DESCRIPTION OF THE DRAWINGS

FIG. 1 illustrates a schematic cross-section view of a fluid delivery apparatus according to one embodiment.

FIG. 2 illustrates a pictorial view of a fluid delivery apparatus according to one embodiment.

FIG. 3 illustrates a pictorial view of a prior art tube assembly.

FIG. 4 illustrates a pictorial view of components of a tube assembly according to one embodiment.

FIG. 5A illustrates a pictorial view of a heating element, temperature sensor and temperature control unit for a fluid delivery apparatus according to one embodiment.

FIG. 5B illustrates a temperature control unit and cable suitable for use with a fluid delivery apparatus according to one embodiment.

### DETAILED DESCRIPTION

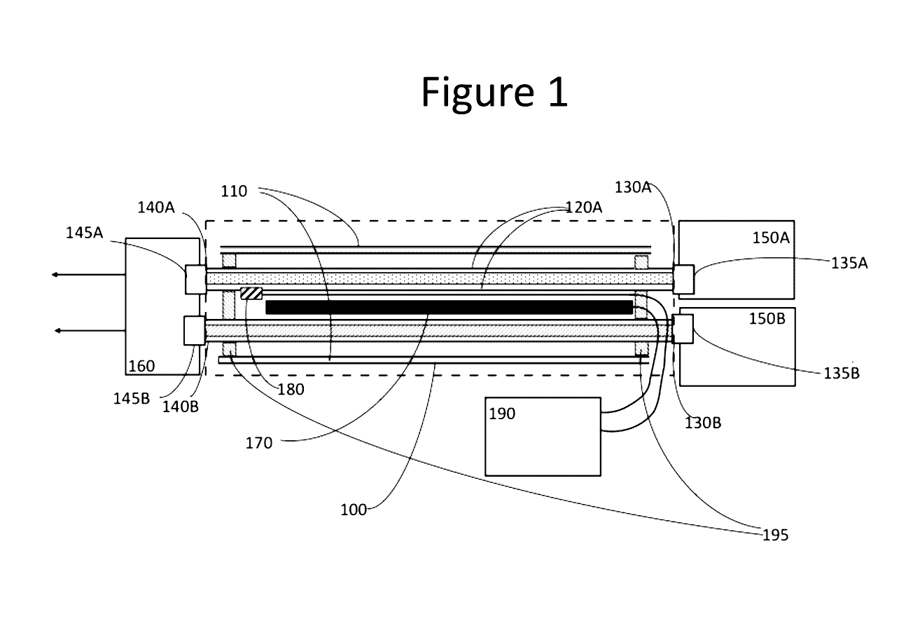

The manner in which the present invention provides its advantages can be more easily understood with reference to FIGS. 1 through 5B.

FIG. 1 illustrates a schematic view of a fluid delivery apparatus according to one embodiment, in which tube assembly 100 is shown in a longitudinal cross-section. Tube assembly 100 includes outer tube 110 and first inner tube 120A. First input end 130A of first inner tube 120A is configured to removably attach to first output port 135A of source 150A, which supplies the fluid of interest, such as water. First inner tube 120A further comprises first output end 140A, configured to removably attach to first input port 145A of dental handset 160. The inner structure of dental handset 160 is not shown, for simplicity; for the purposes of this disclosure, it is understood to be any standard handset, as used in current dental practice, that is able to receive a fluid at an input port and deliver it to an output element (indicated by the top arrow in the figure) that may be positioned in close proximity to a patient's mouth. Similarly, the inner structure of source 150A is not shown, for simplicity; source 150A is understood to be any convenient source of the fluid of interest, able to deliver that fluid through an output port into tubes such as tube 120A.

Tube assembly 100 also includes heating element 170, running alongside first inner tube 120A for almost the entire length of that tube. While the figure shows an air gap between 120A and heating element 170 for visual clarity, in reality, there must be good thermal contact between heating element 170 and first inner tube 120A to achieve high thermal efficiency; this is typically achieved by minimizing the apace between them. In some embodiments, the material of the wall of tube 120A is chosen to have high thermal conductivity. Suitable choices include thermally conductive silicone rubber composites. Such materials have the additional advantages of mechanical flexibility and low cost.

In some embodiments, heating element 170 may be simply placed alongside the wall of tube 120A, running lengthwise as shown in the figure. In other embodiments, heating element 170 may be coiled around tube 120, so that it follows a helical path around 120A, into and out of the plane of the figure as well as extending from right to left as shown. In some embodiments, a thermally conductive material, such as a thermal grease compound, may be inserted between heating element 170 and tube 120A. Heating element 170 may be a simple resistive heater, delivering thermal energy to its environment—ultimately the fluid within first inner tube 120A—via I²R heating, where R is the electrical resistance characterizing the element and the current I is supplied by temperature control unit 190.

In many embodiments, almost the entire length of inner tube 120A is in direct thermal contact with heater element 170. In some embodiments, the length of heating element 170 is substantially equal to the length of inner tube 120A.

In the interests of safety and comfort as well as thermal efficiency and effectiveness in controlling fluid temperature, it is desirable that the material making up the wall of outer tube 110 be thermally insulating. One good choice for that material is a thermally insulating silicone rubber, which also has good mechanical flexibility and is of relatively low cost. In some embodiments, the space between inner tube 120A and outer tube 110 comprises air.

Tube assembly 100 also includes temperature sensor 180, which may be of any of a variety of well-known temperature sensor types; a simple thermocouple, for example, or a thermo-resistive or infrared sensor. In all cases, there must be good thermal contact between the sensor and the fluid of interest, either by direct physical contact with first inner tube 120A, or indirectly via a path of low thermal resistance. In the embodiment of FIG. 1, sensor 180 is positioned against the wall of first inner tube 120A. It may be advantageous to position sensor 180 close to the first output end 140A of first inner tube 120A, so that it measures the fluid temperature close to the point at which the fluid exits assembly 100. An output signal from sensor 180 is fed back to temperature control unit 190, where any of a range of well-known feedback control methods may be used, responding to that sensor output signal to adjust the output from unit 190 that drives heating element 170. In some simple embodiments, the difference between the measured temperature signal and a target desired signal (approximately corresponding to body temperature, for example) is used as an error signal that determines the magnitude to the current sent to a resistive heating element 170. Such a control system is conceptually similar to that used in a well-known domestic product—an electric blanket, controlled by a simple manually-set thermostat.

In some embodiments, the temperature control unit may adjust the drive to the heating element to reach and maintain a predetermined temperature value. In other embodiments, the objective may be to reach and maintain a temperature value within a predetermined temperature range. In one experimental example, the range is +/−5 deg F., but it is envisaged that in improved embodiments, the range will be narrower.

In some embodiments, more than one temperature sensor may be present within tube assembly 100, with the output signals from each being used either separately or in combination to feed into control unit 190 and correspondingly determine the output from control unit 190 that drives heating element 170. In some embodiments, one temperature sensor may be positioned close to the input end of first inner tube 120A to monitor the temperature of the fluid entering the tube, providing this information to temperature control unit 190 in addition to the temperature information provided by another temperature sensor, positioned close to the output end of the tube as shown in FIG. 1.

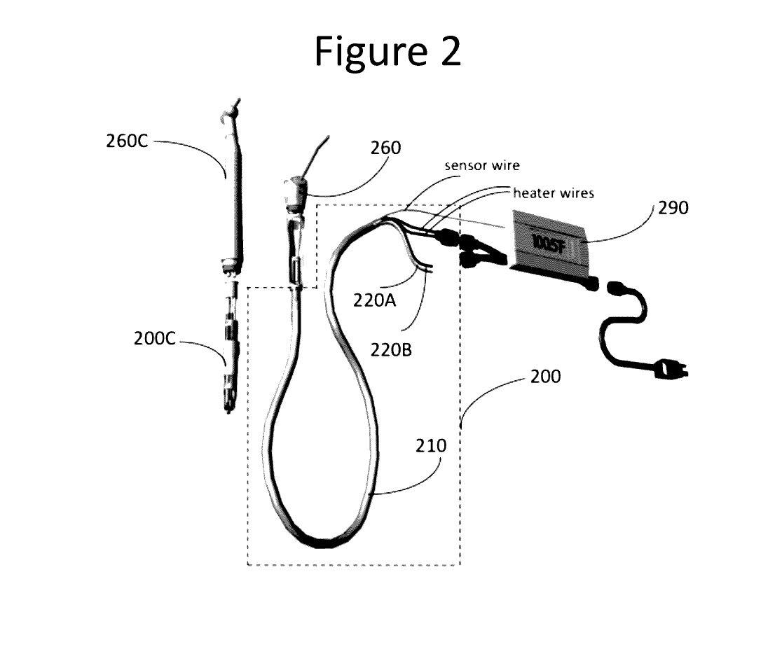

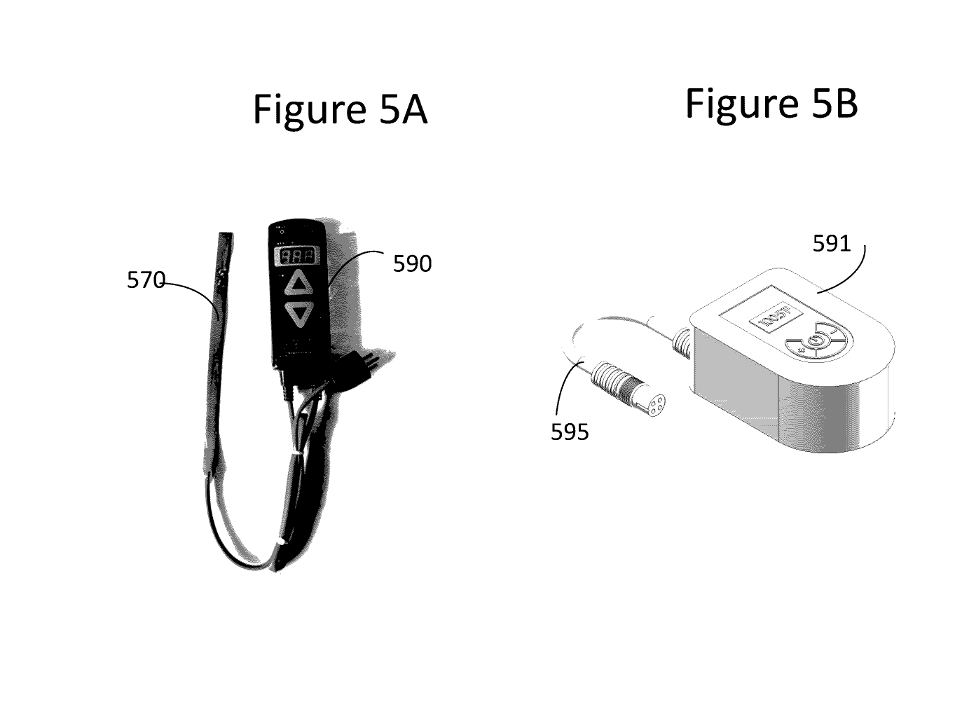

In the embodiment of FIG. 1, temperature control unit 190 is connected to heating element 170 and sensor 180 of tube assembly 100 by wires, which may simply plug into receiving ports on unit 190 (not shown), but unit 190 is not included as part of tube assembly 100. In other embodiments, a temperature control unit may be an integral part of a tube assembly of the present invention, as will be discussed further below, in connection with FIGS. 2 and 5.

As standard dental handsets generally convey two fluids—water and air—to the patient, some embodiments of the current invention accommodate the provision of two fluids by including an additional, second inner tube 120B within tube assembly 100, as shown in FIG. 1. Second inner tube 120B comprises second input end 130B, configured to removably attach to second output port 135B of source 150B, supplying the second fluid. Second inner tube 120B further comprises second output end 140B, configured to removably attach to second input port 145B of dental handset 160. Good thermal contact is provided between heater 170 and second inner tube 120B in the same way as for first inner tube 120A, by appropriate positioning of the heater and tube, appropriate choice of the tube wall material, and optionally including an intervening material of high thermal conductivity. In the case shown, heater 170 is “sandwiched” between first and second inner tubes 120A and 120B. A thermally conductive silicone paste may be present (not shown) bonding heater 170 to facing outer surfaces of the inner tubes. In some embodiments, heater 170 may be coiled around the combination of both tubes. In other embodiments, heater 170 may be configured to provide heat more directly to one inner tube (and so to the fluid within that tube) than to the other, relying on a secondary thermal transfer process to convey heat to the other tube (and so to that corresponding fluid).

In many embodiments, almost the entire length of inner tube 120B is in direct thermal contact with heater element 170. In some embodiments, the length of heating element 170 is substantially equal to the length of inner tube 120B.

In some embodiments, temperature sensor 180 is positioned between first and second inner tubes 120A and 120B, as shown in FIG. 1. In some embodiments, sensor 180 may be positioned closer to one inner tube than to the other, so that the temperature of the fluid within the former tube is monitored more directly, and the assumption is made that that temperature is very close to the temperature of the fluid within the latter tube.

One example of the apparatus of the current invention includes the choice of a conductive silicone rubber tube for the first and second inner tubes, and a conductive silicone rubber heating element integrated with one or both. Such an assembly provides good heat transfer in a mechanically flexible tubing assembly.

In some embodiments, tube assembly 100 may include a sheath lying within outer tube 110 and surrounding the combination of first and second inner tubes. The material of the sheath may be chosen to be thermally insulating, confining as much heat as possible to the region containing the fluids of interest, and maintaining outer tube 110 at close to room temperature. In some embodiments, the tube may be formed from a heat-shrinkable PVC tube, encapsulating the inner, fluid-conveying tubes. PVC is thermally insulating, and serves to keep the outer tube cool and easy to handle, as well as, of course, minimizing thermal losses to the environment. The result is a tubing assembly that looks and feels like the tubing assemblies of the prior art, while delivering temperature controlled fluids with higher efficiency and fewer concerns regarding bacterial growth than comparable systems of the prior art.

FIG. 2 shows a pictorial view of one embodiment of tube assembly 200, attached to a standard “3-Way Air-Water-Spray” handset 260. The cut-away portion of assembly 200 at the top right hand side of the figure shows outer tube 210, portions of inner tubes 220A and 220B, wires to the heating element and a wire carrying signals from a temperature sensor. The heating element and the temperature sensor are not explicitly shown but are present within outer tube 210. Digital thermostat control unit 290 is shown, with its connecting ports for the temperature sensor wire and the heating element cable. On the left side of the figure, an alternative “High Speed” handset 260C is shown, with a portion of a corresponding tube assembly 200C. Some details of the inner tubes and connections at the top of tube assembly 200C differ from those of assembly 200, but the essential features are unchanged from the arrangements described above.

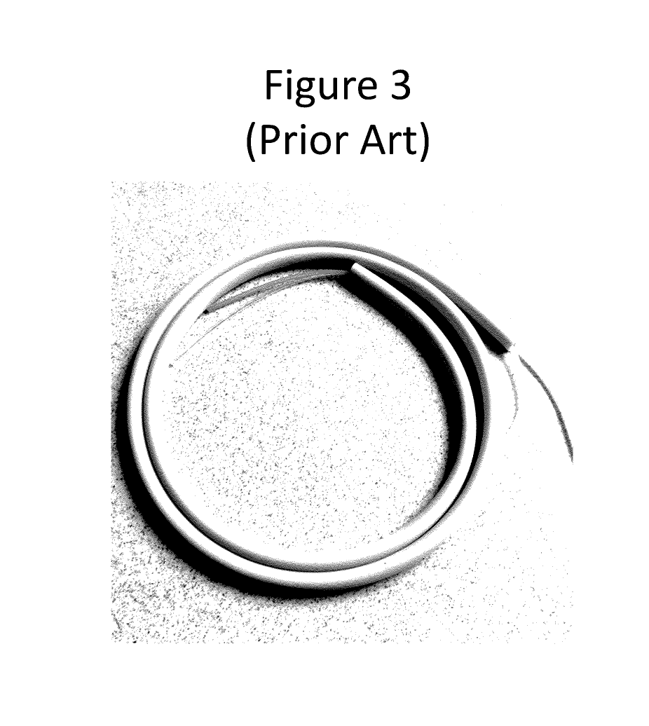

FIG. 3 illustrates a prior art tubing assembly, as used with a simple handset that handles just two fluid streams—an air input and a water input. Other prior art tubing assemblies designed for more complicated handsets may have more than two inner tubes, for example, one for low pressure air input, one for high pressure air input, one for air exhaust, and one for water.

In some embodiments of the current invention, a tube assembly such as assembly 100 shown in FIG. 1 or assembly 200 shown in FIG. 2 may be provided as one element of a temperature controlled fluid delivery system that further includes the temperature control unit that controls the temperature of the heating element in response to a signal received from the temperature sensor. In other embodiments, a tube assembly such as assembly 100 or 200 may be provided as a simple “drop-in” replacement of a standard tube assembly of the prior art, such as that shown in FIG. 3.

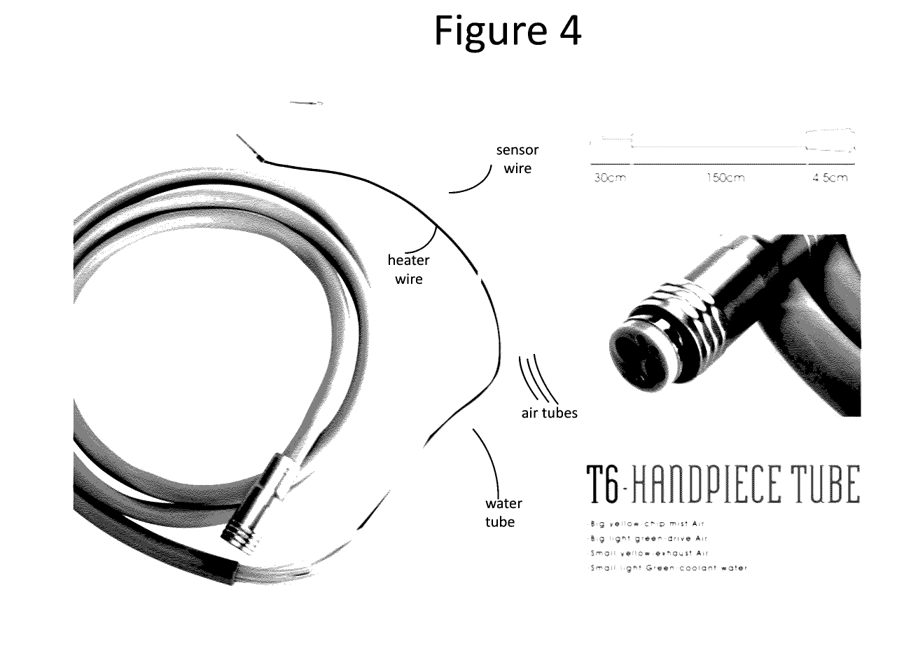

FIG. 4 illustrates parts of a tubing assembly according to one embodiment of the current invention, which in addition to four tubes (three for air and one for water) also includes wires, one connecting to a heating element and one to a temperature sensor. The sensor is not shown but present within the lumen of outer tube 410. An end view of one end of the assembly at the right hand side of the figure shows a plug with ports at which connections may be made to corresponding fluid intake ports at the dental handset.

FIG. 5A illustrates one embodiment of heating element 570, taking the form of a flattened rectangular block. In this example, a temperature sensor (not visually distinguishable in the figure) is integrated along with the packaged heating element. The sensor, which is relatively small, may be located at any desired position along the length of heating element 570, as discussed above. Wires connected to the sensor and the heating element are contained within the cable that splits into two at the temperature controller unit 590. Unit 590 can be plugged into a standard electrical power supply as indicated. This embodiment is an example of one subset of embodiments of the current invention, in which the temperature control elements (heater, sensor and control units) are conveniently packaged together, and then arranged as required within and around a separate tubing assembly. FIG. 5B illustrates a temperature control unit 591 that may be used with a different subset of embodiments of the present invention, in which a tubing assembly (such as that shown in FIG. 4) is provided in a form that already contains the sensor and heater element integrated and sealed within it, and connections to a separate, external temperature control unit, such as 591, may be conveniently made via a suitable plug-in cable 595 as shown.

One major feature of the invention (in comparison to prior art approaches to fluid temperature control for dental applications) is apparent in the various embodiments described above and illustrated by the corresponding figures—the inclusion of heating and sensing components within the tubing assembly connecting the fluid source to the dental handset, rather than within the handset or the source. The interaction between the heating element and the fluid occurs over a long distance (typically between 1 m and 2 m) allowing efficient heat transfer to occur, and readily available, relatively low cost material choices for the tubing walls serve to keep manufacturing costs (and therefore costs to the purchaser) low while maintaining high thermal efficiency. Migrating from a prior art system that lacks thermal control to a system that incorporates the current invention can be as simple as replacing the standard tubing assembly, such as the one shown in FIG. 3, with a tubing assembly that includes the heating element and sensor, such as the one shown in FIG. 4, and either connecting that to a temperature control unit or using an integrated unit, such as the one shown in FIG. 5. Switching on the temperature control unit after the appropriate “plumbing” connections have been made between the inner tube or tubes to the source and handset ports then enables the complete system to operate, delivering the temperature controlled fluid or fluids to the handset.

In addition to thermal efficiency, and the cost and convenience advantages mentioned above, limiting the heating element and the sensor to the tubing assembly, with waterproof seals positioned at each end of the assembly, means that the dental handset itself can be sterilized in the usual fashion between uses, without risk of any adverse effects on those heating and sensing components.

In this application, the term “configured to” is defined to mean that the structural element recited before the term has a size, shape, and in some cases, additional features that are structured by design such that the action recited after the term is inherently enabled. For example, stating that the first input end is “configured to removably attach to a first source port of a first system delivering a first fluid” is a compact way of saying that the first input end has the right size and shape and other structural features to allow it to be attached to and detached from a first source port of that type. The first end may be threaded, for example, such that it can screw into or onto a correspondingly threaded port of the source containing the fluid of interest, or it may plug into a port receptacle on that source.

In this application, the term “substantially” is defined to mean approximately, with a margin of +/−10%

The above-described embodiments should be considered as examples of the present invention, rather than as limiting the scope of the invention. Various modifications of the above-described embodiments of the present invention will become apparent to those skilled in the art from the foregoing description and accompanying drawings. Accordingly, the present invention is to be limited solely by the scope of the following claims.

1. An apparatus that delivers a temperature-controlled fluid to a dental handset, the apparatus comprising:
a tube assembly comprising:
an outer tube;
a first inner tube comprising:
a first input end configured to removably attach to a first source port of a first system delivering a first fluid;
a first output end configured to removably attach to a first input port in the dental handset;
a heating element making good thermal contact with the first inner tube;
and
a first temperature sensor;
wherein the heating element and the first temperature sensor are configured to be operably connected to a temperature control unit such that the temperature control unit controls the heating element in response to a signal received from the temperature sensor.

2. The apparatus of claim 1 wherein the tube assembly additionally comprises a second inner tube comprising:
a second input end configured to removably attach to a second source port of a second system delivering a second fluid; and
a second output end configured to removably attach to a second input port in the dental handset;
wherein the heating element further makes good thermal contact with the second inner tube.

3. The apparatus of claim 2 wherein the first fluid is water and the second fluid is air.

4. The apparatus of claim 2 wherein the first inner tube is characterized by a first length, the second inner tube is characterized by a second length, and the heating element is characterized by a third length, the first length, the second length, and the third length being substantially equal.

5. The apparatus of claim 2 wherein the outer tube comprises a tube wall comprising a thermally insulating material.

6. The apparatus of claim 5 wherein the thermally insulating material comprises a silicone rubber.

7. The apparatus of claim 2 wherein the first and second inner tubes comprise first and second tube walls respectively, each comprising a thermally conductive material.

8. The apparatus of claim 7 wherein the thermally conductive material is a silicone rubber.

9. The apparatus of claim 5 wherein the tube assembly further comprises a sheath wrapped around the combination of the first inner tube, the second inner tube, and the heating element.

10. The apparatus of claim 9 wherein the sheath comprises a thermally insulating material.

11. The apparatus of claim 1 wherein the temperature sensor and the heating element are contained within a single casing.

12. The apparatus of claim 4 wherein the tube assembly additionally comprises a second temperature sensor operably connected to the temperature control unit, one of the first and second temperature sensors being positioned close to the first input end of the first inner tube, and the other of the first and second temperature sensors being positioned close to the first output end of the first inner tube.

13. A method of providing a first temperature-controlled fluid to a dental handset, the method comprising:
attaching a first input end of a first inner tube to a first source port of a first system delivering a first fluid;
attaching a first output end of the first inner tube to a first input port of the dental handset; and
switching on a temperature control unit operably connected to a heater element in good thermal contact with the first inner tube and to a temperature sensor in good contact with the first inner tube;
wherein the first inner tube is contained within an outer tube; and
wherein the temperature control unit is configured to control the heating element in response to a signal received from the temperature sensor.

14. The method of claim 13 further comprising providing a second temperature-controlled fluid to a dental handset by additionally carrying out the following steps:
attaching a second input end of a second inner tube contained within the outer tube to a second source port of a second system delivering a second fluid; and
attaching a second output end of the second inner tube to a second input port of the dental handset;
wherein the heating element further makes good thermal contact with the second inner tube.

15. The method of claim 13 wherein the outer tube comprises a tube wall comprising a thermally insulating material.

16. An apparatus that delivers a temperature-controlled fluid to a dental handset, the apparatus comprising:
a tube assembly comprising:
an outer tube;
a first inner tube comprising:
a first input end configured to removably attach to a first source port of a first system delivering a first fluid;
a first output end configured to removably attach to a first input port in the dental handset;
a heating element making good thermal contact with the first inner tube;
and
a first temperature sensor; and
a temperature control unit configured to control the heating element in response to a signal received from the temperature sensor.

17. The apparatus of claim 16 wherein the tube assembly additionally comprises a second inner tube comprising:
a second input end configured to removably attach to a second source port of a second system delivering a second fluid; and
a second output end configured to removably attach to a second input port in the dental handset;
wherein the heating element further makes good thermal contact with the second inner tube.

18. The apparatus of claim 17 wherein the first fluid is water and the second fluid is air.

19. The apparatus of claim 17 wherein the first inner tube is characterized by a first length, the second inner tube is characterized by a second length, and the heating element is characterized by a third length, the first length, the second length, and the third length being substantially equal.

20. The apparatus of claim 17 wherein the outer tube comprises a tube wall comprising a thermally insulating material.
